(19) United States
(12) Patent Application Publication
(10) Pub. No.: US 2016/0123037 A1
(43) Pub. Date: May 5, 2016

(54) TUMBLER DISC

(71) Applicant: Tuure AALTO, Lemi (FI)

(72) Inventor: TUURE AALTO, Lemi (FI)

(21) Appl. No.: 14/891,076

(22) PCT Filed: May 6, 2014
(86) PCT No.: PCT/FI2014/050332

§ 371 Date: Nov. 13, 2015

(30) Foreign Application Priority Data
May 15, 2013 (FI) 20135518

(51) Int. Cl. E05B 21/06

(52) U.S. Cl. CPC E05B 21/066

(57) ABSTRACT

The invention relates to a tumbler disc of a disc tumbler cylinder lock. It is formed by a substantially circular disc (1) having a central hole (2) that corresponds to the cross-sectional profile of the key for that lock and a limiter (3). According to the invention, the tumbler disc (1) includes a groove (4) that extends inwards from the outer periphery thereof and deviates from the radial direction of the tumbler disc with a width that is smaller than the width of the locking bar of the lock.

### FIELD OF THE INVENTION

The invention relates to a tumbler disc of a disc tumbler cylinder lock according to the preamble of claim 1.

### BACKGROUND OF THE INVENTION

A disc tumbler cylinder lock has an inner cylinder and an outer cylinder as well as, within the inner cylinder, a number of tumbler discs, into a central opening of which a key of the lock can be inserted. When the key is turned, the tumbler discs turn at an angle determined by the notches of the key in such a way that the notches for a locking bar provided at the outer edge of the tumbler discs become aligned in such a way that the locking bar that holds the inner cylinder and the outer cylinder in a fixed relation to each other is able to move to the area of the inner cylinder only. This way, the locking between the cylinders opens and the inner cylinder is able to turn as the key is turned further and the lock is opened.

Traditionally, the locksmith has a ready set of different tumbler discs, i.e. tumbler discs in which the notch of the outer periphery mentioned above is provided in different positions. When the lock is assembled, the locksmith places different tumbler discs in the inner cylinder in an order determined by the notches of the key for that lock. In general, a zero tumbler disc is used as the first or the last disc, the notch for the locking bar at the outer periphery thereof being from one edge beveled, i.e. not provided in the radial direction of the tumbler disc, as both edges of the notches of the other tumbler discs. This raising bevel plays a role when the lock is locked, i.e. to ensure that, when the key is turned, the locking bar rises out from the groove formed by the tumbler discs and locks the inner cylinder and the outer cylinder in an unturnable relationship to each other.

However, the prior art described above has some defects. The locksmith must always have a large number of different tumbler discs, and it takes great precision and manual dexterity to load, in the correct position and correct order, the tumbler discs in the inner cylinder in the order determined by the notches of the key. Thus, attempts have been made to develop means and methods by which the grooves could be made after the tumbler discs are positioned in the inner cylinder. This, in turn, has introduced the further problem that the raising bevel, i.e. a different groove, cannot be made in one or more tumbler discs; instead, the machining edge naturally machines through the entire disc pack a similar and coinciding groove.

### OBJECTIVE OF THE INVENTION

The objective of the invention is to remedy the above-mentioned defects of the prior art. In particular, the objective of the invention is to disclose a new tumbler disc, i.e. a basic tumbler disc, by which one tumbler disc it is possible to replace the most common currently used different tumbler discs.

### SUMMARY OF THE INVENTION

The tumbler disc of a disc tumbler cylinder lock according to the invention is formed by a substantially circular disc having a central hole that corresponds to the cross-sectional profile of the key for that lock and a limiter that limits to a desired degree the turning of the tumbler disc. In general, the limiter is a small projection provided on the outer periphery of the tumbler disc but may also be disposed in the middle of the tumbler disc, i.e. in connection with the key hole. According to the invention, the tumbler disc includes a groove that extends inwards from the outer periphery thereof and deviates from the radial direction of the tumbler disc with a width that is smaller than the width of the locking bar of the lock. It can be thus stated that the invention is a basic tumbler disc having no ready-made peripheral notches for the locking bar, but only a narrow beveled groove so narrow that the locking bar neither fits therein nor hits on it. Furthermore, the beveled groove being positioned at the raising zero, there is provided, when a groove is worked in this tumbler disc, a joint groove formed by that groove and the beveled groove, one edge of the groove being beveled.

According to the invention, the inner cylinder can thus be always provided with a number of identical basic tumbler discs, the discs turned by a key to either extreme position, and a joint groove for the locking bar worked in a similar form in all discs. The beveled groove forms in the zero tumbler disc a raising bevel, while in the other tumbler discs the beveled groove has no effect on the disc, the disc's operation or the working of the groove to be made therein.

The width of the groove is suitably substantially smaller than the width of the locking bar, for example in such a way that the width of the groove is 10-50%, for example approximately 20-30%, of the width of the locking bar. It is only essential to make the groove so narrow that the locking bar easily slides over it when the tumbler discs are turned.

The depth of the beveled groove in the radial direction of the tumbler disc is preferably substantially equal to the depth of the peripheral notches for the locking bar to be worked in the tumbler disc. Thus, a peripheral notch with a raising bevel, i.e. a trapezoidal groove, is formed. In other words, the beveled groove is provided at the groove to be worked in the tumbler disc so as to form, at one edge of that groove, a raising bevel for raising the locking bar from the groove when the lock is locked.

Suitably, the groove deviates from the radial direction of the tumbler disc in such a way that the beveled edge allows the locking bar to be slightly raised, i.e. shifted. The beveled groove is thus provided at an angle of approximately 15-45°, for example approximately 25°, to the radius of the disc.

### Advantages Provided by the Invention

The tumbler disc of a disc tumbler cylinder lock according to the invention has significant advantages over the prior art. Thanks to the invention, the locksmith can deal with the lock assembling procedure with basic tumbler discs only, i.e. by filling the inner cylinder with only one kind of tumbler discs. Then, just by turning with a key the tumbler discs in either extreme position and by working therein a straight joint groove for the locking bar, all tumbler discs can be completed, including the zero tumbler provided with a raising bevel. One bag of basic tumbler discs instead of the current more than ten different tumbler discs suffices.

### BRIEF DESCRIPTION OF THE DRAWINGS

The invention will be described below in detail with reference to the accompanying drawing, in which

FIG. 1 illustrates one basic tumbler disc according to the invention,

FIG. 2 illustrates the tumbler disc of FIG. 1 provided with a peripheral notch for a locking bar,

FIG. 3 illustrates the tumbler disc of FIG. 1 provided with a peripheral notch having a raising bevel and

FIG. 4 illustrates the tumbler disc of FIG. 1 with a locking bar.

### DETAILED DESCRIPTION OF THE INVENTION

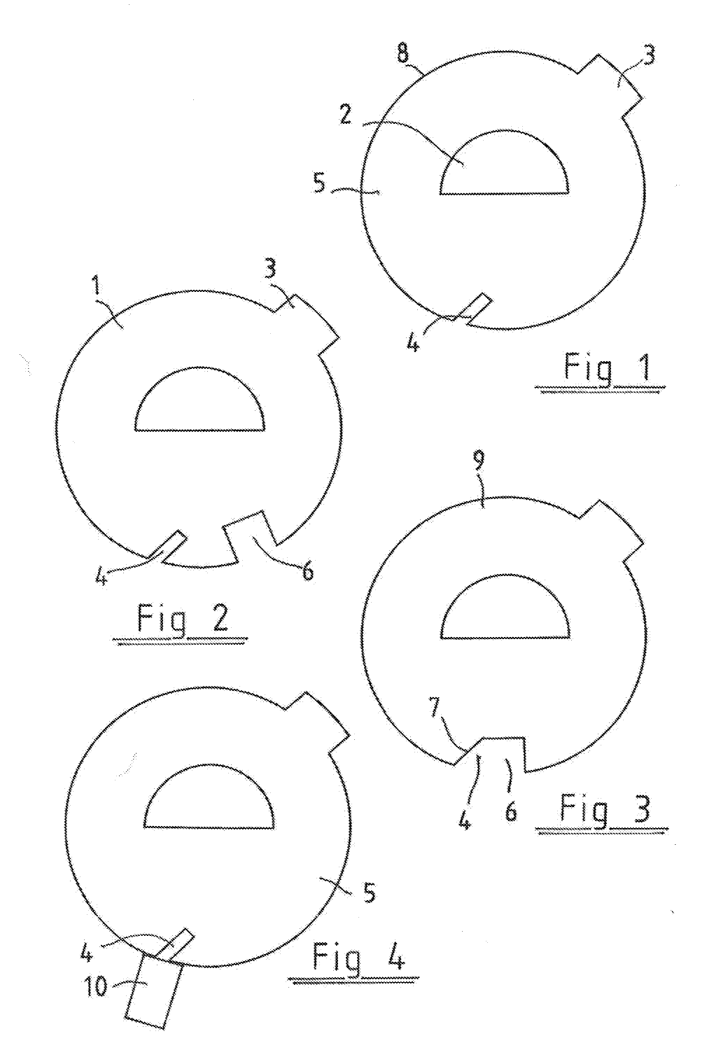

FIG. 1 illustrates the basic tumbler disc 5 according to the invention, i.e. a thin circular disc, centrally provided with a hole 2 that corresponds in form to the profile of a key and having a limiter 3, i.e. a projection, that limits the rotation of the disc on the outer periphery 8 thereof. Further, extending inward from the outer periphery 8 of the disc in a beveled fashion, i.e. deviating from the radial direction of the disc, is a narrow groove 4 having a width that is clearly smaller than the width of the locking bar of the lock.

FIG. 2 illustrates a tumbler disc 1 made from the basic tumbler disc 5 of FIG. 1, i.e. a tumbler disc having, in addition to the parts of FIG. 1, a groove 6 for a locking bar. The groove 6 being clearly separated and spaced apart from the beveled groove 4, the beveled groove has no effect whatsoever on this tumbler disc's operation.

FIG. 3 illustrates a zero tumbler disc 9, i.e. a tumbler disc made from the basic tumbler disc 5, in which the groove 6 has been worked in proximity to the beveled groove 4 in such a way that one edge of the groove 6 forms a raising bevel 7. It is to be noted that it suffices that the beveled groove extends to the bottom of the groove 6, so that, between the grooves 4 and 6, a small triangular section comes off and does not need to be specially removed from the disc.

Further, FIG. 4 illustrates the basic tumbler disc 5 and its operation, i.e. the narrow beveled groove 4 does not prevent the tumbler disc from rotating, as the width of the groove 4 is clearly smaller than the width of the locking bar 10 that rubs against the outer periphery of the tumbler disc.

The invention has been described above by way of example with reference to the accompanying drawings without limiting the invention in any way to the illustrated structures only. Different embodiments of the invention are possible within the scope defined by the claims.

1-8. (canceled)

9. A tumbler disc of a disc tumbler cylinder lock comprising:
a substantially circular disc having a central hole that corresponds to the cross sectional profile of a key for the lock; and
a limiter,
wherein the disc comprises a groove that extends inwards from the outer periphery thereof and deviates from the radial direction of the disc with a width that is smaller than the width of a locking bar of the lock.

10. The tumbler disc of claim 9, wherein the disc is a basic tumbler disc that is free from the peripheral notches for the locking bar of the lock.

11. The tumbler disc of claim 9, wherein the width of the groove is substantially smaller than the width of the locking bar.

12. The tumbler disc of claim 11, wherein the width of the groove is 10-50% of the width of the locking bar.

13. The tumbler disc of claim 11, wherein the width of the groove is 20-30% of the width of the locking bar.

14. The tumbler disc of claim 9, wherein a depth of the groove in a radial direction of the tumbler disc is substantially equal to a depth of peripheral notches for the locking bar to be worked in the tumbler disc.

15. The tumbler disc of claim 9, wherein the groove is provided in the tumbler disc at a second groove to be worked therein in such a way that a raising bevel is formed at one edge of the second groove for raising the locking bar from the second groove when the lock is locked.

16. The tumbler disc according to claim 15, wherein the second groove is provided at the zero groove to be worked in the tumbler disc.

17. The tumbler disc of claim 1, wherein the groove deviates from the radial direction of the tumbler disc for 15-45°.

18. The tumbler disc of claim 1, wherein the groove deviates from the radial direction of the tumbler disc for approximately 25°.
